(19) United States
(12) Patent Application Publication
(10) Pub. No.: US 2008/0071749 A1
(43) Pub. Date: Mar. 20, 2008

(54) Method, Apparatus and Computer Program Product for a Tag-Based Visual Search User Interface

(75) Inventor: Philipp C. Schloter, San Francisco, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/855,409

(22) Filed: Sep. 14, 2007

Related U.S. Application Data
(60) Provisional application No. 60/825,922, filed on Sep. 17, 2006.

(51) Int. Cl. G06F 17/30

(52) U.S. Cl. 707/3; 707/E17.014

(57) ABSTRACT

An apparatus for providing a tag-based visual search user interface may include a processing element. The processing element may be configured to receive an indication of information desired by a user, receive data retrieved based on the indication, the retrieved data including a portion associated with a tag, and replace the tag with corresponding tag data.

### CROSS-REFERENCE TO RELATED APPLICATIONS

The present application claims priority to U.S. Provisional Application No. 60/825,922 filed Sep. 17, 2006, the contents of which are incorporated by reference herein in their entirety.

### FIELD OF THE INVENTION

Embodiments of the present invention generally relates to visual search technology and, more particularly, relate to methods, devices, mobile terminals and computer program products for a tag-based visual search user interface.

### BACKGROUND OF THE INVENTION

The modem communications era has brought about a tremendous expansion of wireline and wireless networks. Computer networks, television networks, and telephony networks are experiencing an unprecedented technological expansion, fueled by consumer demands, while providing more flexibility and immediacy of information transfer.

Current and future networking technologies continue to facilitate ease of information transfer and convenience to users. One area in which there is a demand to increase ease of information transfer and convenience to users relates to provision of various applications or software to users of electronic devices such as a mobile terminal. The applications or software may be executed from a local computer, a network server or other network device, or from the mobile terminal such as, for example, a mobile telephone, a mobile television, a mobile gaming system, video recorders, cameras, etc, or even from a combination of the mobile terminal and the network device. In this regard, various applications and software have been developed and continue to be developed in order to give the users robust capabilities to perform tasks, communicate, entertain themselves, gather and/or analyze information, etc. in either fixed or mobile environments.

With the wide use of mobile phones with cameras, camera applications are becoming popular for mobile phone users. Mobile applications based on image matching (recognition) are currently emerging and an example of this emergence is mobile visual searching systems. Currently, there are mobile visual search systems having various scopes and applications. However, one barrier to the increased adoption of mobile information and data services includes challenges with the user-interface (UI) of the mobile devices that may execute the applications. The mobile devices are sometimes unusable or at best limited in their utility for information retrieval due to limitations imposed by the user interface.

There have been many approaches implemented for making mobile devices easier to use including, for example automatic dictionary for typing text with a number keypad, voice recognition to activate applications, scanning of codes to link information, foldable and portable keypads, wireless pens that digitize handwriting, mini-projectors that project a virtual keyboard, proximity-based information tags and traditional search engines, etc. Each of the approaches have shortcomings such as increased time for typing longer text or words not stored in the dictionary, inaccuracy in voice recognition systems due to external noise or multiple conversations, limited flexibility in being able to recognize only objects with codes and within a certain proximity to the code tags, extra equipment to carry (portable keyboard), training the device for handwriting recognition, reduction in battery life, etc.

Given the ubiquitous nature of cameras in devices such as mobile terminals, there may be a desire to develop a visual searching system providing a user friendly user interface (UI) so as to enable access to information and data services.

### BRIEF SUMMARY OF INVENTION

Systems, methods, devices and computer program products of the exemplary embodiments of the present invention relate to designs of search technology (e.g., mobile search technology) and, more particularly, relate to methods, devices, mobile terminals and computer program products for a tag-based visual search user interface and display. The tag-based user interface of embodiments of the present invention allows reducing the number of clicks required and provides the mechanism by which to immediately display desired (supplemental) information on a mobile device.

In one exemplary embodiment, a method of providing an improved tag-based user interface and information retrieval is provided. The method may include receiving an indication of information desired by a user, receiving data retrieved based on the indication, the retrieved data including a portion associated with a tag, and replacing the tag with corresponding tag data.

In another exemplary embodiment, a computer program product for providing a tag-based visual search user interface is provided. The computer program product includes at least one computer-readable storage medium having computer-readable program code portions stored therein. The computer-readable program code portions include first, second and third executable portions. The first executable portion is for receiving an indication of information desired by a user. The second executable portion is for receiving data retrieved based on the indication. The retrieved data may include a portion associated with a tag. The third executable portion is for replacing the tag with corresponding tag data.

In another embodiment, an apparatus for providing a tag-based visual search user interface is provided. The apparatus may include a processing element. The processing element may be configured to receive an indication of information desired by a user, receive data retrieved based on the indication, the retrieved data including a portion associated with a tag, and replace the tag with corresponding tag data.

In another embodiment, an apparatus for providing a tag-based visual search user interface is provided. The apparatus may include means for receiving an indication of information desired by a user, means for receiving data retrieved based on the indication, the retrieved data including a portion associated with a tag, and means for replacing the tag with corresponding tag data.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 is a schematic block diagram of an embodiment of the present invention;

FIG. 4 is a schematic block diagram of a server and client embodiment of the present invention; and

FIG. 5 is a flowchart for a method of operation to provide a tag-based visual search user interface according to an embodiment of the invention.

### DETAILED DESCRIPTION OF THE INVENTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

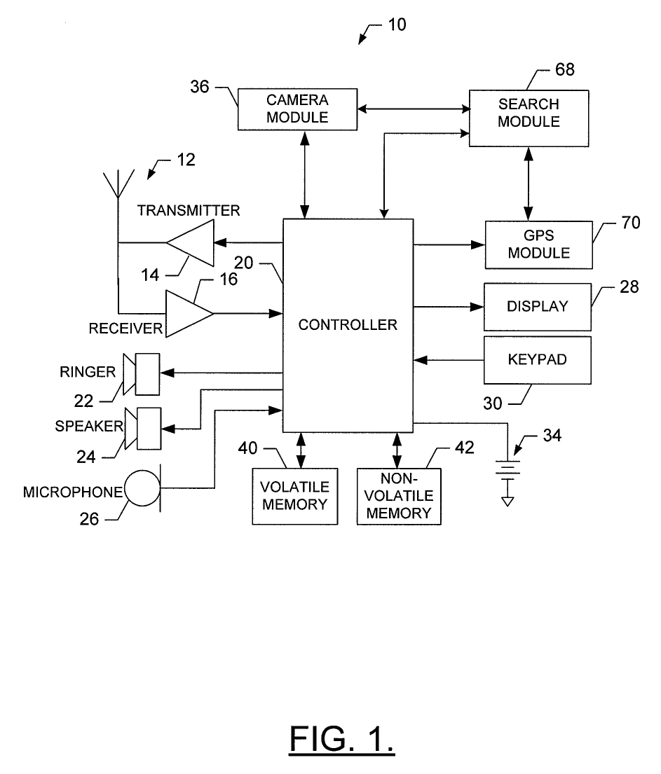

Referring now to FIG. 1, which illustrates a block diagram of a mobile terminal (device) 10 that would benefit from the present invention. It should be understood, however, that a mobile terminal as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDA's), pagers, mobile televisions, laptop computers and other types of voice and text communications systems, can readily employ embodiments of the present invention. Furthermore, devices that are not mobile may also readily employ embodiments of the present invention.

In addition, while several embodiments of the method of the present invention are performed or used by a mobile terminal 10, the method may be employed by other than a mobile terminal. Moreover, the system and method of the present invention will be primarily described in conjunction with mobile communications applications. It should be understood, however, that the system and method of the present invention can be utilized in conjunction with a variety of other applications, both in the mobile communications industries and outside of the mobile communications industries.

The mobile terminal 10 includes an antenna 12 in operable communication with a transmitter 14 and a receiver 16. The mobile terminal 10 further includes an apparatus, such as a controller 20 or other processing element, that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols including IS-136 (TDMA), GSM, and IS-95 (CDMA), third-generation (3G) wireless communication protocol including Wideband Code Division Multiple Access (WCDMA), Bluetooth (BT), IEEE 802.11, IEEE 802.15/16 and ultra wideband (UWB) techniques. The mobile terminal further may be capable of operating in a narrowband networks including AMPS as well as TACS.

It is understood that the apparatus, such as the controller 20, includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 includes a camera module 36 in communication with the controller 20. The camera module 36 may be any means such as a device or circuitry for capturing an image or a video clip or video stream for storage, display or transmission. For example, the camera module 36 may include a digital camera capable of forming a digital image file from an object in view, a captured image or a video stream from recorded video data. The camera module 36 may be able to capture an image, read or detect bar codes, as well as other code-based data, OCR data and the like. As such, the camera module 36 includes all hardware, such as a lens, sensor, scanner or other optical device, and software necessary for creating a digital image file from a captured image or a video stream from recorded video data, as well as reading code-based data, OCR data and the like. Alternatively, the camera module 36 may include only the hardware needed to view an image, or video stream while memory devices 40, 42 of the mobile terminal 10 store instructions for execution by the controller 20 in the form of software necessary to create a digital image file from a captured image or a video stream from recorded video data. In an exemplary embodiment, the camera module 36 may further include a processing element such as a co-processor which assists the controller 20 in processing image data, a video stream, or code-based data as well as OCR data and an encoder and/or decoder for compressing and/or decompressing image data, a video stream, code-based data, OCR data and the like. The encoder and/or decoder may encode and/or decode according to a JPEG standard format, and the like. Additionally, or alternatively, the camera module 36 may include one or more views such as, for example, a first person camera view and a third person map view.

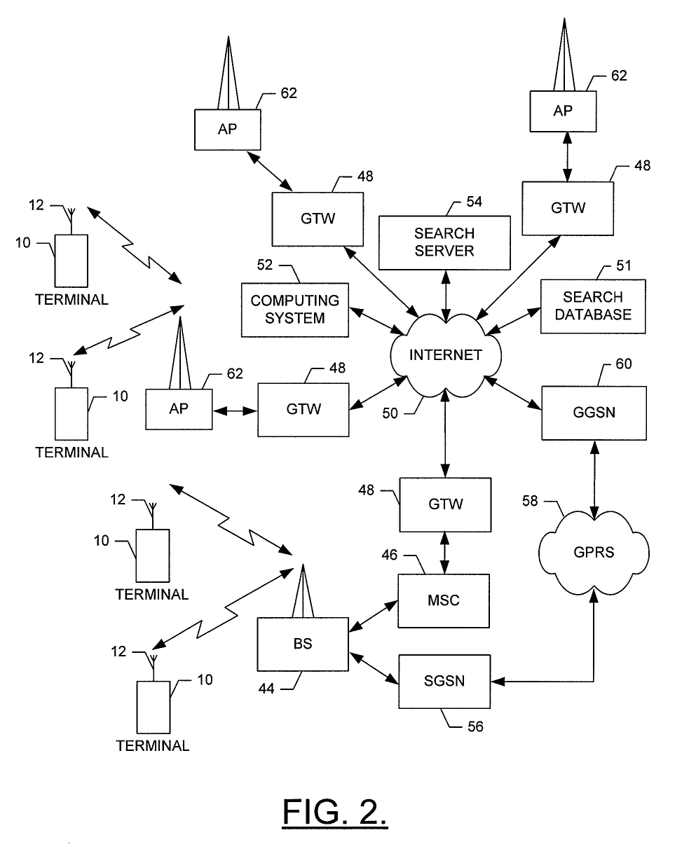

The mobile terminal 10 may further include a GPS module 70 in communication with the controller 20. The GPS module 70 may be any means, device or circuitry for locating the position of the mobile terminal 10. Additionally, the GPS module 70 may be any means, device or circuitry for locating the position of point-of-interests (POIs), in images captured or read by the camera module 36, such as for example, shops, bookstores, restaurants, coffee shops, department stores, products, businesses, museums, historic landmarks etc. and objects (devices) which may have bar codes (or other suitable code-based data). As such, points-of-interest as used herein may include any entity of interest to a user, such as products, other objects and the like and geographic places as described above. The GPS module 70 may include all hardware for locating the position of a mobile terminal or POI in an image. Alternatively or additionally, the GPS module 70 may utilize a memory device(s) 40, 42 of the mobile terminal 10 to store instructions for execution by the controller 20 in the form of software necessary to determine the position of the mobile terminal or an image of a POI. Additionally, the GPS module 70 is capable of utilizing the controller 20 to transmit/receive, via the transmitter 14/receiver 16, locational information such as the position of the mobile terminal 10, the position of one or more POIs, and the position of one or more code-based tags, as well OCR data tags, to a server, such as the visual search server 54 and the visual search database 51, as disclosed in FIG. 2 and described more fully below.

The mobile terminal may also include a search module 68. The search module may include any means of hardware and/or software, being executed or embodied by controller 20, (or by a co-processor internal to the search module (not shown)) capable of receiving data associated with points-of-interest, code-based data, OCR data and the like (e.g., any physical entity of interest to a user) when the camera module of the mobile terminal 10 is pointed at (zero-click) POIs, code-based data, OCR data and the like or when the POIs, code-based data and OCR data and the like are in the line of sight of the camera module 36 or when the POIs, code-based data, OCR data and the like are captured in an image by the camera module. In an exemplary embodiment, indications of an image, which may be a captured image or merely an object within the field of view of the camera module 36, may be analyzed by the search module 68 for performance of a visual search on the contents of the indications of the image in order to identify an object therein. In this regard features of the image (or the object) may be compared to source images (e.g., from the visual search server 54 and/or the visual search database 51) to attempt recognition of the image. Tags associated with the image may then be determined. The tags may include context metadata or other types of metadata information associated with the object (e.g., location, time, identification of a POI, logo, individual, etc.). One application employing such a visual search system capable of utilizing the tags (and/or generating tags or a list of tags) is described in U.S. application Ser. No. 11/592,460, entitled “Scalable Visual Search System Simplifying Access to Network and Device Functionality,” the contents of which are hereby incorporated herein by reference in their entirety.

The search module 68 (e.g., via the controller 20) may further be configured to generate a tag list comprising one or more tags associated with the object. The tags may then be presented to a user (e.g., via the display 28) and a selection of a keyword (e.g., one of the tags) associated with the object in the image may be received from the user. The user may “click” or otherwise select a keyword, for example, if he or she desires more detailed (supplemental) information related to the keyword. As such, the keyword (tag) may represent an identification of the object or a topic related to the object, and selection of the keyword (tag) according to embodiments of the present invention may provide the user with supplemental information such as, a link or links, related to information desired, wherein a link may be a traditional web link, a phone number or a particular application, and may carry a title or other descriptive legend. Furthermore, supplemental information may also comprise a banner wherein a banner is actual information that is self standing i.e. without being associated to a link. The banner may be static or moving. It should be understood that links, titles, actual information and banners or any combination thereof refer to supplemental information or data. However, the data or supplemental information as described above is merely illustrative of some examples of the type of information desired that would benefit from the present invention and, therefore, should not be taken to limit the scope of the present invention.

For example, the user may just point to a POI with the camera module of his or her camera phone, and a listing of keywords associated with the image (or the object in the image) may automatically appear. In this regard, the term automatically should be understood to imply that no user interaction is required in order to the listing of keywords to be generated and/or displayed. Furthermore, the listing of keywords may be generated responsive to a determination of tags associated with the image (or the object in the image) based on recognition of features of the image or the object itself based on a comparison of the image (or image features) to one or more source images. Once the listing of keywords has been displayed, if the user desires more detailed information about the POI the user may make a single click or otherwise select one of the keywords and supplemental information corresponding to the selected keyword may be presented to the user. The search module is responsible for controlling the functions of the camera module 36 such as camera module image input, tracking or sensing image motion, communication with the search server for obtaining relevant information associated with the POIs, the code-based data and the OCR data and the like as well as the necessary user interface and mechanisms for a visual display, e.g., via display 28, or an audible rendering, e.g., via the speaker 24, of the corresponding relevant information to a user of the mobile terminal 10. In an exemplary alternative embodiment the search module 68 may be internal to the camera module 36.

The search module 68 may also be capable of enabling a user of the mobile terminal 10 to select from one or more actions in a list of several actions (for example in a menu or sub-menu) that are relevant to a respective POI, code-based data and/or OCR data and the like. For example, one of the actions may include but is not limited to searching for other similar POIs (i.e., supplemental information) within a geographic area. For example, if a user points the camera module at a historic landmark or a museum the mobile terminal may display a list or a menu of candidates (supplemental information) relating to the landmark or museum for example, other museums in the geographic area, other museums with similar subject matter, books detailing the POI, encyclopedia articles regarding the landmark, etc. As another example, if a user of the mobile terminal points the camera module at a bar code, relating to a product or device for example, the mobile terminal may display a list of information relating to the product including an instruction manual of the device, price of the object, nearest location of purchase, etc. Information relating to these similar POIs may be stored in a user profile in memory.

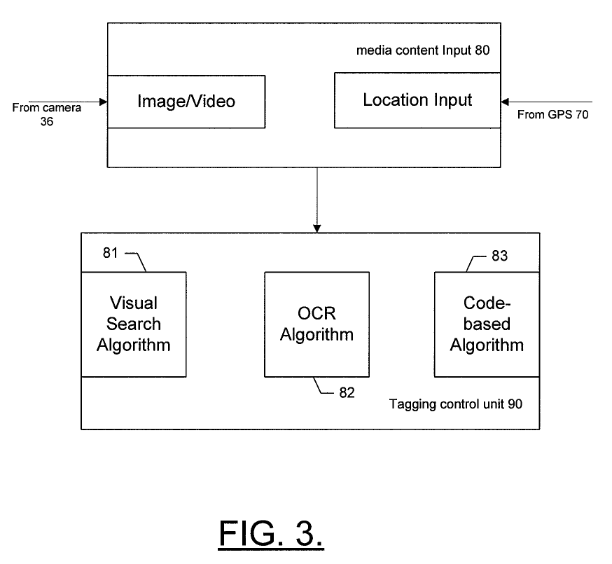

Additionally, the search module 68 includes a media content input 80 (as disclosed in FIG. 3 and described more fully below) capable of receiving media content from the camera module 36, the GPS module 70 or any other suitable element of the mobile terminal 10, and a tagging control unit 135 (as disclosed in FIG. 3 and described more fully below) which receives the image via the media content input 80 capable of creating one or more tags such as, for example code-based tags, OCR tags and visual tags that are linked to physical objects. These tags are then transferred to a visual search server 54 and visual search database 51 (as disclosed in FIG. 2 and described more fully below), wherein the user is provided with information associated with the tag.

Referring now to FIG. 2, which illustrates a type of system that would benefit from the present invention. The system includes a plurality of network devices. As shown, one or more mobile terminals 10 may each include an antenna 12 for transmitting signals to and for receiving signals from a base site or base station (BS) 44 or access point (AP) 62. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and the present invention is not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (one shown in FIG. 2), visual search server 54 (one shown in FIG. 2), visual search database 51, or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or visual map server 54 may be coupled to the mobile terminal 10 via the Internet 50, SGSN 56 and GGSN 60. In this regard, devices such as the computing system 52 and/or visual map server 54 may communicate with the mobile terminal 10 across the SGSN 56, GPRS core network 58 and the GGSN 60. By directly or indirectly connecting mobile terminals 10 and the other devices (e.g., computing system 52, visual map server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G, third-generation (3G) and/or future mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), Wibree, infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like.

The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the visual search server 54, and/or any of a number of other devices, to the Internet 50, the mobile terminals 10 can communicate with one another, the computing system, 52 and/or the visual search server 54 as well as the visual search database 51, etc., to thereby carry out various functions of the mobile terminals 10, such as to transmit data, content or the like to, and/or receive content, data or the like from, the computing system 52. For example, the visual search server 54 may handle requests from the search module 68 and interact with the visual search database 51 for storing and retrieving visual search information. Additionally, the visual search server 54 may provide various forms of data relating to target objects such as POIs to the search module 68 of the mobile terminal. Additionally, the visual search server 54 may provide information relating to code-based data, OCR data and the like to the search module 68. For instance, if the visual search server receives an indication from the search module 68 of the mobile terminal that the camera module detected, read, scanned or captured an image of a bar code or any other codes (collectively, referred to herein as code-based data) and/or OCR data, for e.g., text data, the visual search server 54 may compare the received code-based data and/or OCR data with associated data stored in the point-of-interest (POI) database 74 and provide, for example, comparison shopping information for a given product(s), purchasing capabilities and/or content links, such as URLs or web pages to the search module to be displayed via display 28. That is to say, the code-based data and the OCR data, from which the camera module detects, reads, scans or captures an image, contains information relating to the comparison shopping information, purchasing capabilities and/or content links and the like. When the mobile terminal receives the content links (e.g. URL) or any other desired information such as a document, a television program, music recording, etc., the mobile terminal may utilize its Web browser to display the corresponding web page via display 28 or present the desired information in audio format via the microphone 26. Additionally, the visual search server 54 may compare the received OCR data, such as for example, text on a street sign detected by the camera module 36 with associated data such as map data and/or directions, via a map server, in a geographic area of the mobile terminal and/or in a geographic area of the street sign. It should be pointed out that the above are merely examples of data that may be associated with the code-based data and/or OCR data and in this regard any suitable data may be associated with the code-based data and/or the OCR data described herein. The information relating to the one or more POIs may be linked to one or more tags, such as for example, a tag associated with a physical object that is captured, detected, scanned or read by the camera module 36. The information relating to the one or more POIs may be transmitted to a mobile terminal 10 for display.

The visual search database 51 may store relevant visual search information including but not limited to media content which includes but is not limited to text data, audio data, graphical animations, pictures, photographs, video clips, images and their associated meta-information such as for example, web links, geo-location data (as referred to herein, geo-location data includes but is not limited to geographical identification metadata to various media such as websites and the like and this data may also consist of latitude and longitude coordinates, altitude data and place names), contextual information and the like for quick and efficient retrieval. Furthermore, the visual search database 51 may store data regarding the geographic location of one or more POIs and may store data pertaining to various points-of-interest including but not limited to location of a POI, product information relative to a POI, and the like. The visual search database 51 may also store code-based data, OCR data and the like and data associated with the code-based data, OCR data including but not limited to product information, price, map data, directions, web links, etc. The visual search server 54 may transmit and receive information from the visual search database 51 and communicate with the mobile terminal 10 via the Internet 50. Likewise, the visual search database 51 may communicate with the visual search server 54 and alternatively, or additionally, may communicate with the mobile terminal 10 directly via a WLAN, Bluetooth, Wibree or the like transmission or via the Internet 50.

In an exemplary embodiment, the visual search database 51 may include a visual search input control/interface. The visual search input control/interface may serve as an interface for users, such as for example, business owners, product manufacturers, companies and the like to insert their data into the visual search database 51. The mechanism for controlling the manner in which the data is inserted into the visual search database 51 can be flexible, for example, the new inserted data can be inserted based on location, image, time, or the like. Users may download or insert bar codes or any other type of codes (i.e., code-based data) or OCR data relating to one or more objects, POIs, products or like (as well as additional information) into the visual search database 51, via the visual search input control/interface. In an exemplary non-limiting embodiment, the visual search input control/interface may be located external to the visual search database 51. As used herein, the terms “images,” “video clips,” “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing system 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

Referring now to FIG. 3, a block diagram of an embodiment of the present invention is provided. The tagging control unit 90 receives media content via the media content input 80 and performs an OCR search or a code-based search or a visual search by executing OCR/code-based algorithms 82, 83 (or visual search algorithm 81) so as to generate the tags associated with the received media content. For instance, the user of the mobile terminal may point his/her camera module at an object or capture an image of the object (e.g. a book) which is provided to the tagging control unit 90 via media content input 80. Recognizing that the image of the object (i.e., the book) has text data on its cover, the tagging control unit 90 may execute the OCR algorithm 82 and the tagging control unit 90 may label (i.e., tag) the book according to its title, which is identified in the text data on the book's cover. (In addition, the tagging control unit 90 may tag the detected text on the book's cover to serve as keywords which may be used to search content online via the Web browser of the mobile terminal 10.) The tagging control unit 90 may store this data (i.e., title of the book) on behalf of the user or transfer this information to the visual search server 54 and/or the visual search database 51 so that the server 54 and/or the database 51 may provide this data (i.e., title of the book) to the users of one or more mobile terminals 10, when the camera modules 36 of the one or more mobile terminals are pointed at or capture an image of the book.

The user of the mobile terminal 10 could generate additional tags when the visual search algorithm 81 is executed. For instance, if the camera module 36 is pointed at an object such as, for example, a box of cereal in a store, information relating to this object may be provided to the tagging control unit 90 via media content input 80. The tagging control unit 90 may execute the visual search algorithm 81 so that the search module 68 performs visual searching on the box of cereal. The visual search algorithm may generate visual results such as an image or video clip for example of the cereal box and included in this image or video clip there may be other data such as, for example, price information, a URL on the cereal box product name (e.g., Cheerios™), manufacturer's name, etc., which is provided to the tagging control unit. This data, e.g., price information in the visual search results may be tagged or linked to an image or video clip of the cereal box which may be stored in the tagging control unit on behalf of the user such that when the user of the mobile terminal subsequently points his camera module at or captures media content (an image/video clip) of the cereal box, the display 28 is provided with the information (e.g., price information, a URL, etc.) Additionally, this information may be transferred to visual search server 54 and/or visual search database 51, which may provide users of one or more mobile terminals 10 with the information when the users point the camera module at the cereal box and/or capture media content (an image/video clip) of the cereal box. Again this saves the users of the mobile terminals time and energy required to input meta-information manually by using a keypad 30 or the like in order to create tags.

As noted above, the tags generated by the tagging control unit 90 can be used when the user of the mobile terminal 10 retrieves content from visual objects. Additionally, in view of the foregoing, it should be pointed out that by using the search module 28, the user may obtain embedded code-based tags from visual objects, obtain OCR content added to a visual object, obtain content based on location and keywords (for e.g., from OCR data), and eliminate a number of choices by using keywords-based filtering. For example, when searching information related to a book, the input from an OCR search may contain information such as author name and book title which can be used as keywords to filter out irrelevant information.

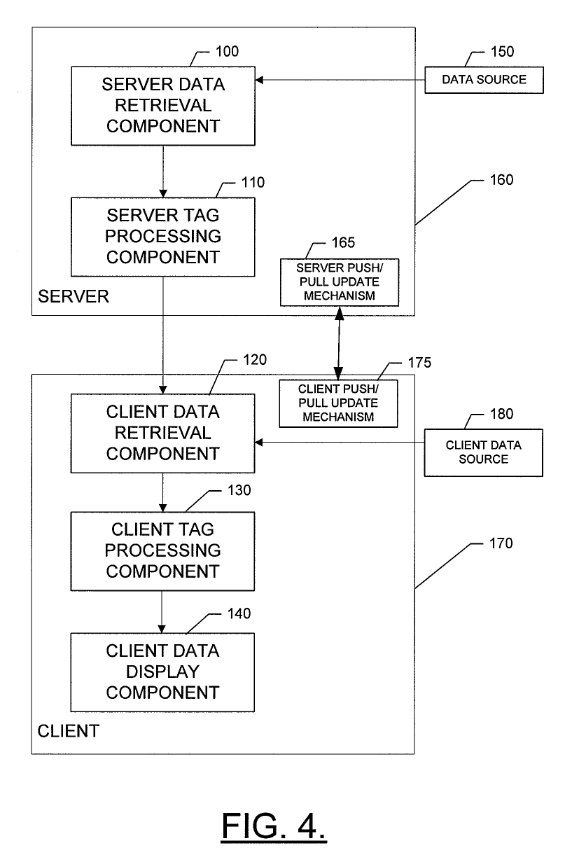

Reference is now made to FIG. 4, which illustrates a server 160 and a client 170 capable of communication with each other and other data sources in accordance with an exemplary embodiment of the present invention. However, it should be noted that other architectures besides a server/client architecture may also be employed. The server 160 and the client 170 may be examples of servers and clients (e.g., the mobile terminal 10) discussed above. Additionally, although each of the server 160 and the client 170 will be described below in terms of comprising various components, it should be understood that the components may be embodied as or otherwise controlled by a corresponding processing element or processor of the server 160 and the client 170, respectively. In this regard, each of the components described below may be any device, means or circuitry embodied in hardware, software or a combination of hardware and software that is configured to perform the corresponding functions of the respective components as described in greater detail below.

In this regard, the server 160 may be capable of establishing communication with one or more data sources such as, for example, data source 150. In this regard, the data source 150 may be on-site or off-site (e.g., local or remote) with respect to the server 160. Moreover, the data source 150 may include various different data formats for the data stored therein. Examples of some format sources may include RSS, XML, HTML and various other formats. Either the server 160, the data source 150 or a proxy device in communication with the server 160 and/or the data source 150 may be configured to translate between formats in some cases to ensure data received at the server 160 is in a useable format. Types of data accessed by the server may be widely varied. Examples of data types may include, but are not limited to, text, links, directory entries, zip codes, maps, websites, images, weather information, traffic information, news, user information, properties, and many other types. In an exemplary embodiment, the server 160 could also connect to a central sensor to obtain data. The data obtained by the server 160 may be utilized in accordance with exemplary embodiments of the present invention to provide supplemental information to the client (user) 170. In this regard, as will be described in greater detail below, tags similar to those described above, which may be associated with particular retrieved data (e.g., a particular image (or object in an image)), may be replaced with corresponding data retrieved from the data source 150 or other accessible data sources.

As illustrated in FIG. 4, the server 160 may include a server data retrieval component 100 and a server tag processing component 110, each of which may be any device, means or circuitry embodied in hardware, software or a combination of hardware and software that is configured to perform the corresponding functions of the server data retrieval component 100 and the server tag processing component 110, respectively, as described in greater detail below. The server data retrieval component 100 may be configured to retrieve (e.g., by pulling) data from the data source 150 or other data sources in communication with the server 160. Additionally, the server data retrieval component 100 may be configured to categorize incoming data (whether such data has been pulled from a data source or pushed to the server data retrieval component 100). The server data retrieval component 100 may also be configured to cache data in certain situations (e.g., especially if such data is retrieved on a routine basis).

The server tag processing component 110 may be configured to process the retrieved data communicated to the server tag processing component 110 (e.g., from the server data retrieval component 100). In an exemplary embodiment, the processing performed by the server tag processing component 110 may include the replacement of portions of the retrieved data with other portions of the retrieved data on the basis of the tags within the retrieved data. In this regard, for example, a part of the retrieved data may be processed to identify a tag associated therewith, and the part associated with the tag may be replaced with other parts of the retrieved data (if available). In an exemplary embodiment, data replacements such as those described above may be conditional. For example, such data replacements may depend on other data variables and current values or conditions. In other words, conditional statements or Boolean expressions (e.g., if/then or case statements) may be utilized to define conditions which, when met, may trigger the replacement of data associated with a tag, with other data from the retrieved data. Processed data may then be communicated to the client 170 (or to other clients).

Table 1 illustrates an example of a list of tags that could be used in an embodiment of the present invention. However, it should be understood that the tags provided in Table 1 are merely examples and are by no means limiting with respect to the tags that may be utilized in connection with embodiments of the present invention. Rather, Table 1 merely represents how tags, which can be identified by the server tag processing component 110, may look.

TABLE 1

| Selected Example Tags | Description |
|---|---|
| [PX.LOC.CITY] | name of city at current location |
| [PX.LOC.STATE] | two letter state of current location |
| [PX.LOC.CITYID] | ID associated with current city |
| [PX.LOC.COUNTRY] | name of current country |
| [PX.LOC.ZIP] | Current zipcode |
| [PX.LOC.LON] | Current longitude |
| [PX.LOC.LAT] | Current latitude |
| [PX.PIC.TXT] | Text recognized with text recognition engine in picture (either |
| | on server or client). Format, language and engine type can be |
| | specified. |
| [PX.PIC.RESULT 1] | Associated top result with object in picture |
| [PX.PIC.BARCODE] | Bar code recognized with barcode recognition engine in picture |
| | (either on server or client). Format and engine type can be |
| | specified. |
| [PX.INFO.TRAFFIC] | Local traffic information |
| [PX.INFO.WEATHER] | Local weather forecast |
| [PX.INFO.NEWS] | News for a certain location, time, news type |
| [PX.TIME.TIME] | Time in hh:mm:ss |
| [PX.TIME.DATE] | Date |
| {PX.KEY.TEXTBOX( . . . )} | Display a textbox and ask user for text input via keypad or |
| | keyboard |
| [PX.SENSOR.TEMPERATURE] | Temperature at sensor |
| {PX.IF(STATEMENT, THEN, | If statement supporting statement any mathematical expression |
| OTHERWISE)} | with tags, then result and otherwise result |
| [PX.USER.FIRSTNAME] | First name of current user |
| [PX.USER.PHONENUMBER] | Phone number of current user |
| . . . | . . . |

As shown in FIG. 4, the client 170 may include a client data retrieval component 120, a client tag processing component 130 and a client data display component 140, each of which may be any device, means or circuitry embodied in hardware, software or a combination of hardware and software that is configured to perform the corresponding functions of the client data retrieval component 120, the client tag processing component 130 and the client data display component 140, respectively, as described in greater detail below. The client data retrieval component 120 may be similar to the server data retrieval component 100 described above, except that the client data retrieval component may not only be configured to retrieve (e.g., by pulling) data from a client data source 180 or other data sources, but the client data retrieval component 120 may also be configured to retrieve data from the server 160 (e.g., via the server tag processing component 110). The client data retrieval component 120 may also be configured to access data of different types and in different formats as described above. Additionally, the client data retrieval component 120 may be configured to connect to local sensors to obtain data including, but not limited to, GPS (or assisted GPS), Cell ID or other location information, temperature, speed, acceleration, directions, image sensor data, OCR and/or bar-code information, fingerprint information or other biometric information, voice input, keyboard input, joystick input, mouse input, movements or any other sensor data. The client data retrieval component 120 may also be configured to categorize incoming data (e.g., whether such data has been pulled from a data source or from the server 160, or whether the server 160 has pushed the data to the client data retrieval component 120). Data may be retrieved from accessible sources as desired. However, the client data retrieval component 120 may also be configured to cache data in certain situations (e.g., especially if such data is retrieved on a routine basis).

The client tag processing component 130 may be similar to the server tag processing component 110 described above. In this regard, for example, the client tag processing component 130 may be configured to process the retrieved data communicated to the client tag processing component 130 (e.g., from the client data retrieval component 120 or from the server 160). In an exemplary embodiment, the processing performed by the client tag processing component 130 may include the replacement of portions of the retrieved data with other portions of the retrieved data on the basis of the tags within the retrieved data. In this regard, for example, a part of the retrieved data may be processed to identify a tag associated therewith, and the part associated with the tag may be replaced with other parts of the retrieved data (if available). In an exemplary embodiment, as described above with respect to the server tag processing component 110, data replacements such as those described herein may be conditional. For example, such data replacements may depend on other data variables and current values or conditions. In other words, conditional statements or Boolean expressions (e.g., if/then or case statements) may be utilized to define conditions which, when met, may trigger the replacement of data associated with a tag, with other data from the retrieved data. Processed data may then be communicated to the client data display component 140.

Upon receipt of data (e.g., processed data) from the client tag processing component 130, the client data display component 140 may be configured to display the received data or provide information for display corresponding to the data received. In an exemplary embodiment, the client data display component 140 may be configured to consider the status of the client 170 (e.g., search mode, receiving keyboard inputs, receiving results from a visual search, etc.) in determining whether to, or how to, display the received data. The data displayed may have all of the tags replaced with relevant tag data (see Table 1 for examples). Alternatively, only those tags that meet conditional requirements may be replaced with corresponding data. In this regard, the replacement of tags with corresponding data may have taken place at either the server tag processing component 110 or the client tag processing component 130. As such, for example, in some embodiments, only one of the server tag processing component 110 or the client tag processing component 130 may be employed.

Data displayed by the client data display component 140 may, in one embodiment, be overlaid on top of a viewfinder display or a live video or other image on a display of a camera or mobile terminal. The displayed data may represent search results from a visual search, based on an object that the user places within the field of view of, for example, the camera module 36. The displayed data may include a link, a title, a banner and/or other information, any of which may include dynamic information that is adjusted based on factors such as location, user properties, time, text from a text recognition engine, social network inputs, or other like inputs. In this regard, while the visual search may return a general associated link to be provided for display, the replacement of tags with corresponding information may enable an otherwise static link, title or banner, to include dynamic features due to the replacement of tags with corresponding data that may be dynamic. Accordingly, the actual displayed link may be dynamic.

Results (e.g., the final processed information presented for display) may be displayed in a list, circle, hierarchy or any other like form to enable the user to interact with the results. In this regard, the user may highlight a certain result (e.g., without clicking) and read more information overlaid on the display. Another click may then lead to further information or perform another function.

In an exemplary embodiment, in order to update changing input data as new data is retrieved, two particular mechanisms may be employed. For example, a client push/pull update mechanism 175 or a server push/pull update mechanism 165 may be employed. The client push/pull update mechanism 175 and the server push/pull update mechanism 165 may each be any device, means or circuitry embodied in hardware, software, or a combination of hardware and software that is configured to perform the corresponding functions of the client push/pull update mechanism 175 and the server push/pull update mechanism 165, respectively. In this regard, for example, the server push/pull update mechanism 165 and the client push/pull update mechanism 175 may be configured to accommodate a client pull or a server push of updates to the client 170. Both push and pull approaches may be combined, or only one of the two approaches may be implemented in alternate embodiments.

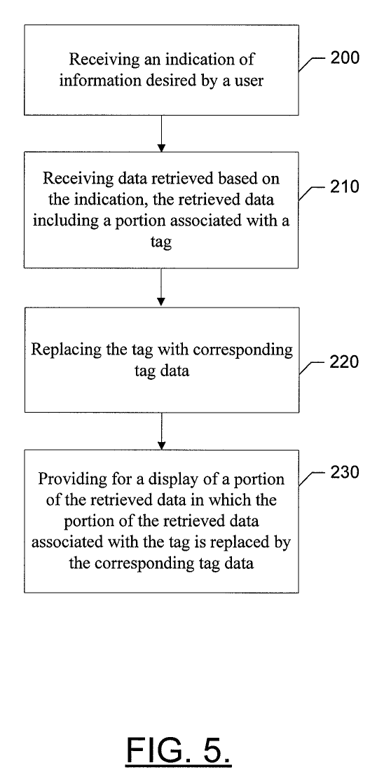

FIG. 5 is a flowchart of a method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal or server and executed by a built-in processor in a mobile terminal or server. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing a tag-based visual search user interface as illustrated, for example, in FIG. 5, may include receiving an indication of information desired by a user at operation 200. At operation 210, data retrieved based on the indication may be received. The retrieved data may include at least a portion of the retrieved data that is associated with a tag. The tag may then be replaced with corresponding tag data at operation 220. However, in some embodiments, a determination may be made as to whether a condition for tag replacement is met prior to replacing the tag and the tag may only be replaced if the condition for tag replacement is met. In an exemplary embodiment, the method may further include an optional operation of providing for a display of a portion of the retrieved data in which the portion of the retrieved data associated with the tag is replaced by the corresponding tag data at operation 230. The portion of the retrieved data that is displayed may be displayed as an overlay with respect to real-time image data displayed on a device of the user.

In an exemplary embodiment, the indication of information desired by the user that is received may include receiving an indication of an image including an object and the method may further include conducting a visual search based on the object. In another embodiment, replacing the tag may include consulting a table of tags and corresponding tag data in order to identify tag data to use for replacing the tag.

In various exemplary embodiments, receiving data retrieved may include receiving data at a client device or at a server device. When such data is received at the client device, the data may be received subsequent to a pull operation to pull the retrieved data to the client device from a server in communication with the client device or subsequent to a push operation to push the retrieved data to the client device from a server in communication with the client device. When the data is received at the server, the data may be received for subsequent communication to the client device, in which the data is received in response to a pull operation to pull the retrieved data to the client device or in response to a push operation to push the retrieved data to the client device.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving an indication of information desired by a user;
receiving data retrieved based on the indication, the retrieved data including a portion associated with a tag; and
replacing the tag with corresponding tag data.

2. The method of claim 1, further comprising providing for a display of a portion of the retrieved data in which the portion of the retrieved data associated with the tag is replaced by the corresponding tag data.

3. The method of claim 2, wherein providing for the display comprises displaying the portion of the retrieved data as an overlay with respect to real-time image data displayed on a device of the user.

4. The method of claim 1, wherein receiving the indication of information desired by the user comprises receiving an indication of an image including an object and wherein the method further comprises conducting a visual search based on the object.

5. The method of claim 1, wherein replacing the tag comprises consulting a table of tags and corresponding tag data in order to identify tag data to use for replacing the tag.

6. The method of claim 1, further comprising determining whether a condition for tag replacement is met prior to replacing the tag and replacing the tag only if the condition for tag replacement is met.

7. The method of claim 1, wherein receiving data retrieved comprises receiving data at a client device subsequent to a pull operation to pull the retrieved data to the client device from a server in communication with the client device.

8. The method of claim 1, wherein receiving data retrieved comprises receiving data at a client device subsequent to a push operation to push the retrieved data to the client device from a server in communication with the client device.

9. The method of claim 1, wherein receiving data retrieved comprises receiving data at a server for subsequent communication to a client device, the data being received in response to a pull operation to pull the retrieved data to the client device.

10. The method of claim 1, wherein receiving data retrieved comprises receiving data at a server for subsequent communication to a client device, the data being received in response to a push operation to push the retrieved data to the client device.

11. A computer program product comprising at least one computer-readable storage medium having computer-readable program code portions stored therein, the computer-readable program code portions comprising:
a first executable portion for receiving an indication of information desired by a user;
a second executable portion for receiving data retrieved based on the indication, the retrieved data including a portion associated with a tag; and
a third executable portion for replacing the tag with corresponding tag data.

12. The computer program product of claim 11, further comprising a fourth executable portion for providing for a display of a portion of the retrieved data in which the portion of the retrieved data associated with the tag is replaced by the corresponding tag data.

13. The computer program product of claim 12, wherein the fourth executable portion includes instructions for displaying the portion of the retrieved data as an overlay with respect to real-time image data displayed on a device of the user.

14. The method of claim 11, wherein the first executable portion includes instructions for receiving an indication of an image including an object and wherein the method further comprises a fourth executable portion for conducting a visual search based on the object.

15. The computer program product of claim 11, wherein the third executable portion includes instructions for consulting a table of tags and corresponding tag data in order to identify tag data to use for replacing the tag.

16. The computer program product of claim 11, further comprising a fourth executable portion for determining whether a condition for tag replacement is met prior execution of the third executable portion, wherein the third executable portion is executed only if the condition for tag replacement is met.

17. An apparatus comprising a processing element configured to:
receive an indication of information desired by a user;
receive data retrieved based on the indication, the retrieved data including a portion associated with a tag; and
replace the tag with corresponding tag data.

18. The apparatus of claim 17, wherein the processing element is further configured to provide for a display of a portion of the retrieved data in which the portion of the retrieved data associated with the tag is replaced by the corresponding tag data.

19. The apparatus of claim 18, wherein the processing element is further configured to display the portion of the retrieved data as an overlay with respect to real-time image data displayed on a device of the user.

20. The apparatus of claim 17, wherein the processing element is further configured to receive an indication of an image including an object and to conduct a visual search based on the object.

21. The apparatus of claim 17, wherein the processing element is further configured to consult a table of tags and corresponding tag data in order to identify tag data to use for replacing the tag.

22. The apparatus of claim 17, wherein the processing element is further configured to determine whether a condition for tag replacement is met prior to replacing the tag and replacing the tag only if the condition for tag replacement is met.

23. An apparatus comprising:
means for receiving an indication of information desired by a user;
means for receiving data retrieved based on the indication, the retrieved data including a portion associated with a tag; and
means for replacing the tag with corresponding tag data.

24. The apparatus of claim 23, further comprising means for providing for a display of a portion of the retrieved data in which the portion of the retrieved data associated with the tag is replaced by the corresponding tag data.

25. The apparatus of claim 23, further comprising means for determining whether a condition for tag replacement is met prior to replacing the tag and replacing the tag only if the condition for tag replacement is met.
